(19) United States
(12) Patent Application Publication
(10) Pub. No.: US 2010/0223897 A1
(43) Pub. Date: Sep. 9, 2010

(54) VEHICLE MOUNTED EDGE TRIMMER

(76) Inventor: David L. MILLS, Blackshear, GA (US)

Correspondence Address: GARDNER GROFF GREENWALD & VILLANUEVA. PC, 2018 POWERS FERRY ROAD, SUITE 800, ATLANTA, GA, 30339, US

(21) Appl. No.: 12/717,253

(22) Filed: Mar. 4, 2010

Related U.S. Application Data
(60) Provisional application No. 61/157,385, filed on Mar. 4, 2009.

(51) Int. Cl. A01D 34/416

(52) U.S. Cl. 56/12.7

(57) ABSTRACT

A lawn-mower mounted trimmer apparatus with a trimmer head and an arm connecting the trimmer head to a mower or other vehicle. The trimmer optionally has a steering mechanism and/or a trimmer angle control mechanism, wherein the arm can be controlled side to side, and the angle of the trimmer head relative to the ground can be varied.

### CROSS-REFERENCE TO RELATED APPLICATION

This application claims the benefit of U.S. Provisional Patent Application Ser. No. 61/157,385, filed Mar. 4, 2009, the entirety of which is hereby incorporated herein by reference for all purposes.

### TECHNICAL FIELD

The present invention relates generally to the field of lawn maintenance, and more particularly to a mower-mounted steerable edger or weed trimmer.

### BACKGROUND OF THE INVENTION

There are many devices which allow a user to perform weed trimming functions and grass mowing functions. Typically, however, a user must perform these two functions independently with separate tools. A mower such as a push mower or riding mower is used for cutting larger open areas, and a string trimmer or edger is used to trim around trees, structures and other areas that are not easily accessed by the mower. The edger is usually carried or pushed by the user. This process can be labor intensive and time consuming.

### SUMMARY OF THE INVENTION

In example forms, a string trimmer or edger is controllably mounted to a lawn mower or other vehicle. For example, a riding mower, self-propelled mower or push mower can be provided with a trimmer attachment having controls for steering (left, right, up and/or down) the trimmer adjacent or integrated with the controls for the mower. The system can include a weed trimmer head mounted to the distal end of an arm or linkage, with the second end of the arm or linkage secured to the vehicle. The trimmer optionally also has an angle control mechanism, wherein the angle control mechanism controls the angle of the arm with respect to a vehicle.

The trimmer can be consolidated in a mower deck as original equipment. One or more controllable trimmer attachments can be mounted in the front left or right corner or both corners, or mounted in the center front of the mower, and swing left or right or locked straight ahead and controlled to move up or down to cross uneven ground. The trimmer head(s) can take various forms, including a string trimmer, a brush blade, a hedge trimmer, a chain or blade saw, an edger, and/or alternate mechanisms. Other components, such as a sprayer, a seed broadcaster, an aerator, a rake, etc. may be incorporated in addition to, or in place of, one or more trimmer attachment components.

The trimmer can be driven from the blade belt, a power-take-off coupling, a driveshaft, a direct power connection to the mower engine, a hydraulic or pneumatic motor, a battery-operated electric motor, a separate engine, or other drive means. One or more carrier or leveling wheels may be provided to support the trimmer attachment, and/or to maintain a consistent cutting height. In an example form, four full floating trimmer caster wheels are provided. The trimmer head can optionally rotate or tilt 90 degrees into a vertical orientation, to allow installation of blades, for maintenance, or to convert a horizontal trimmer into a vertical edger for edging along curbs, driveways, beds or the like. The inclination angle of the trimmer head relative to the ground can optionally be adjustable and/or controllable, for example at one or more incremental positions between 0°-90° inclination relative to the horizontal. Optionally, the mounting arm or linkage includes a quick-disconnect detachable coupling to allow easy interchangeability between different heads for different jobs.

A spring or support member optionally extends from the top of the mower to the trimmer head to support the trimmer, and allow extension and retraction as the operator steers the attachment left or right as desired. The provision of a spring-mounted or otherwise compressible or retractable coupling member also allows the trimmer to move upwardly and/or laterally away from an obstruction if it impacts an obstruction, without damaging the trimmer or the mounting structure. One or more steering cables, hydraulic or pneumatic cylinders, motors, or other steering drive actuator means allow the operator to control the trimmer attachment straightforward, left or right, to trim under bushes, between trees etc., and optionally also can be used to raise and lower the trimmer up and down to trim above bricks, rocks, etc. and/or to vary the cutting height.

The trimmer can preferably be operated with or without the lawn mower blade running, and the mower blade can preferably be operated with or without the trimmer running. Both the mower blades and trimmer strings can be operated at the same time, or both can be shut down. Thus, the system of the present invention allows mowing and trimming to be done simultaneously, or consecutively without switching between two different pieces of equipment, and on one pass around buildings, roads, etc. The trimmer can be controlled with one or more hand controllers, foot pedals, or other actuators to operate the trimmer head with the user's hand, foot, or other movement.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of the invention are exemplary and explanatory of preferred embodiments of the invention, and are not restrictive of the invention, as claimed.

### BRIEF DESCRIPTION OF THE DRAWINGS

FIG. 1 is a front view of a weed trimmer according to an example form of the invention steered to the right.

FIG. 2 is a front view of the weed trimmer of FIG. 1 steered to the left.

FIG. 3 is a front view of another embodiment of a weed trimmer according to example form of the invention with the weed trimmer steered to the left.

FIG. 4 is a detailed left side view of the trimmer of FIG. 3.

FIG. 5 is a detailed right side view of the trimmer of FIG. 3, shown in a vertically tilted configuration.

FIG. 6 is a perspective view of the weed trimmer of FIG. 3, shown in an example mode of operation.

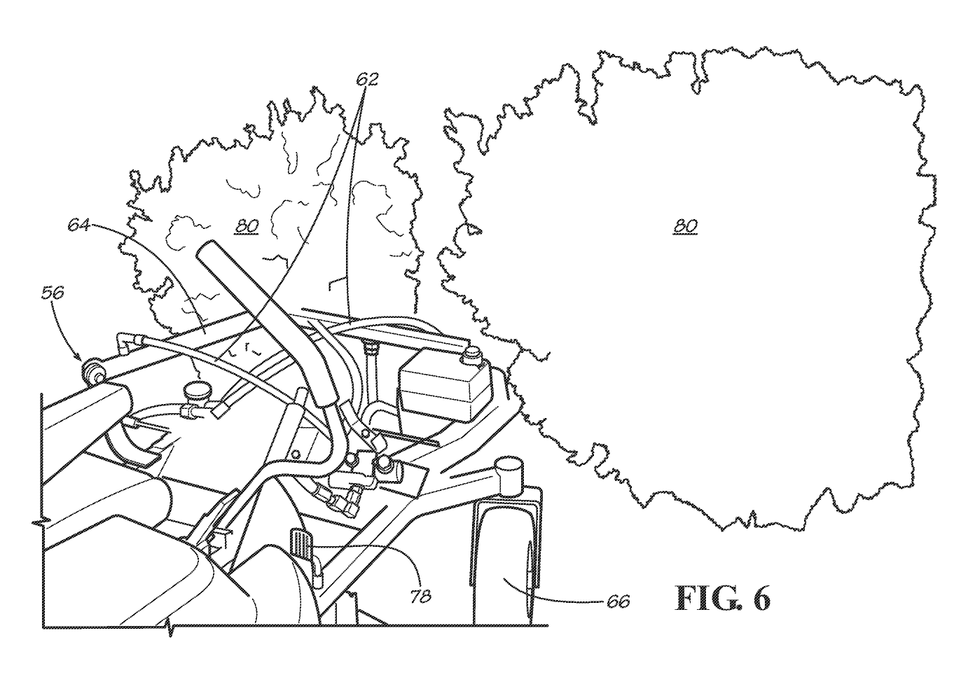

FIG. 7 shows an alternative cutting head application incorporating a chain saw in a vertically tilted configuration.

FIG. 8 is a view of the embodiment of FIG. 7, shown in a horizontal configuration.

### DETAILED DESCRIPTION OF EXAMPLE EMBODIMENTS

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

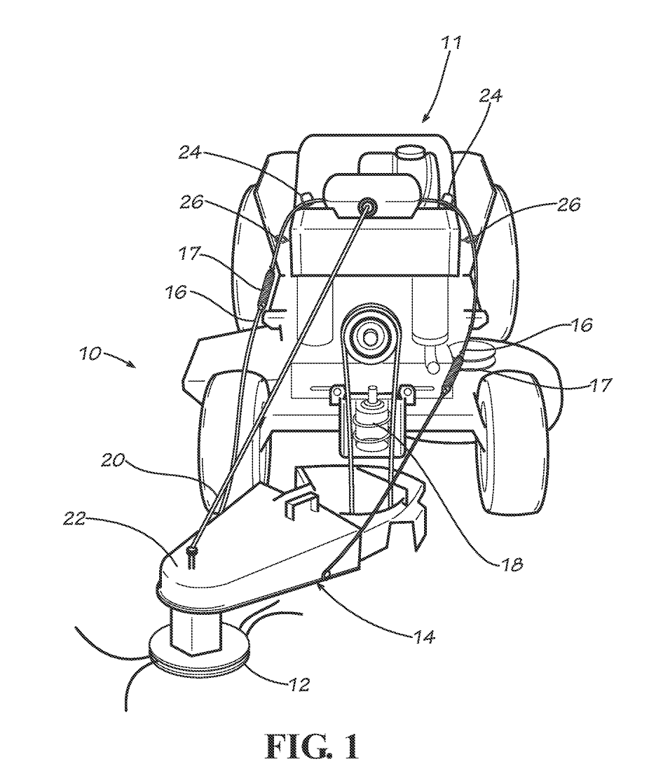

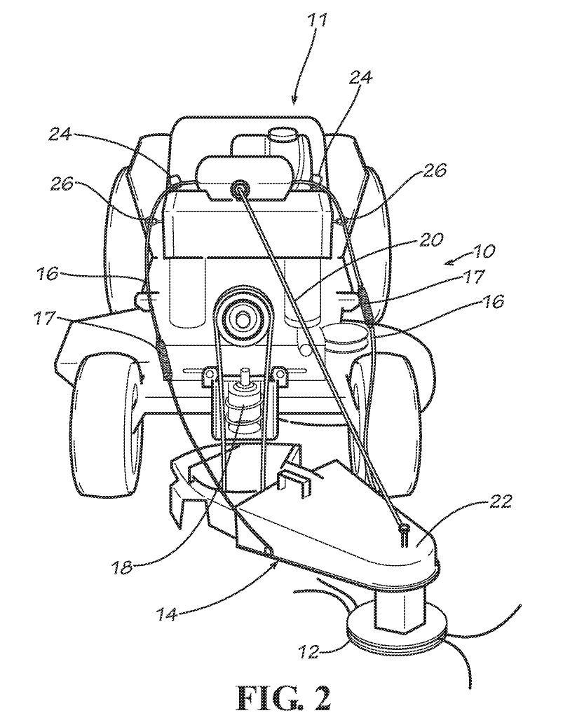

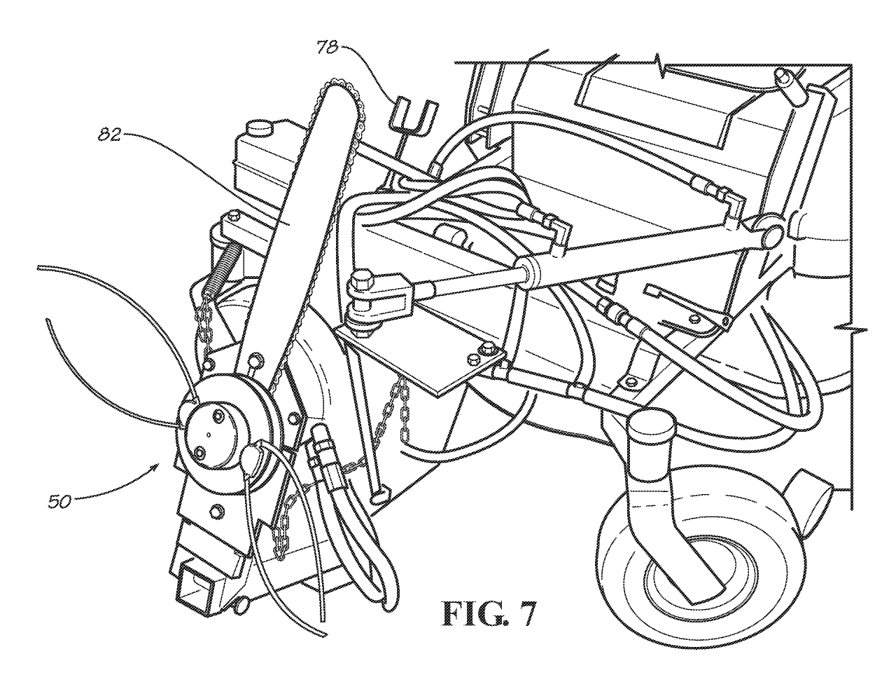

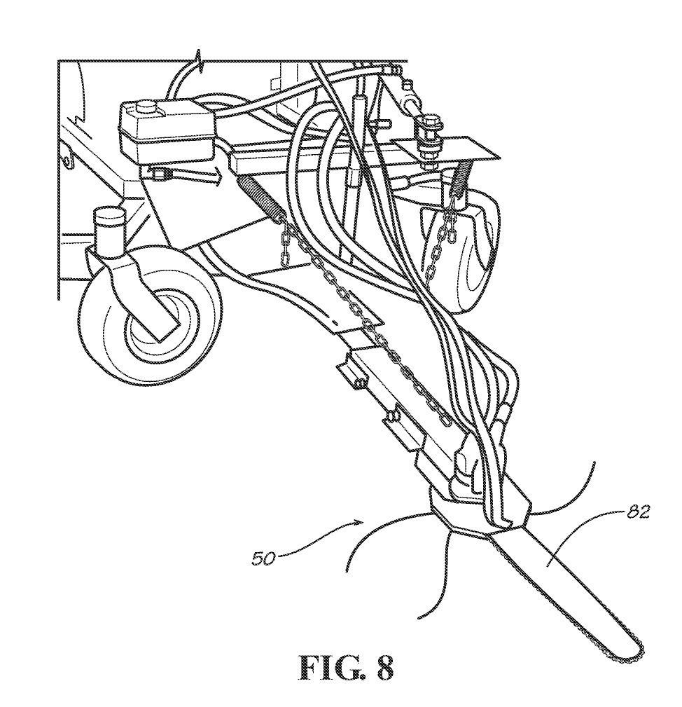

With reference now to the drawing figures, wherein like reference numbers represent corresponding parts throughout the several views, FIGS. 1-2 show an example embodiment of a trimmer attachment mounted to a riding lawn mower according to one form of the invention. As shown, the device 10 is operable in conjunction with a riding mower 11, but could be incorporated with other types of mowers or vehicles such as an automobile or an all terrain vehicle. The vehicle is preferably motor-driven, as for example by an internal combustion engine or an electric motor. The weed trimmer 10 can incorporate a tool or cutting head in the form of a string trimmer, a blade mechanism (see FIGS. 7 and 8), or other implement. The trimmer 12 is secured to an arm 14. The trimmer 12 is driven by a belt drive transmission coupled to a drive pulley of the mower, or alternatively can be powered by a separate gas or electric motor. As shown, the arm 14 is an elongated structure that has a first end and a second end. As shown, the trimmer 10 is secured to a first end of the arm 14, and the arm 14 is secured to a vehicle 11 with a mounting structure 18. An example form of a mounting structure 18 is a ball joint or a swivel coupling, so as to allow the arm 14 to swing to the left (FIG. 2) and right (FIG. 1).

A spring support or brace 20 provides support for the arm 14 and trimmer 12. As shown, moving parts within the arm 14 and trimmer 12 are protected by a shroud or cover 22. The example embodiment shown in FIGS. 1-2 includes a steering mechanism 16. As shown, the steering mechanism 16 comprises one or more lengths of flexible cable or wire. The cable or wire 16 is secured to the arm 14 near the wire trimmer 12. As shown the cable or wire 16 extends from the arm 14 toward the vehicle 11, and may be connected to one or more foot pedals or hand-operated steering actuators 24. In operation a user can control the angle of the arm 14 by controlling the length of the cable or wire 16 through manipulation of the steering actuator(s) 24. As an example, FIG. 1 shows the arm 14 angled to the right with respect to the vehicle 11. A user desiring to make the arm 14 rotate to the right would retract the cable or wire 16 secured to the right side of the arm 14, and allow the opposite steering cable to extend.

FIG. 2 shows the arm 14 angled to the left with respect to the vehicle 11. A user desiring to make the arm 14 rotate to the left would retract the cable 16 secured to the left side of the arm 14. As shown in FIG. 2, the example embodiment includes a handle 24 secured at a position on the cable 16. Two or more handles 24 can be secured at different positions on the cable 16 to allow a user to pull either the right or left side. The cable 16 can be secured to the vehicle 11 by running through eyelets 26 mounted to the vehicle 11. As shown in FIG. 1-2 the cable 16 can be one continuous length and extends from the right side of the arm 14 up through the eyelets 26 and down to the left side of the arm 14. Alternatively, a single cable 16 can extend from one side of the arm 14 through a first eyelet 26 and secured by a handle 26 secured at its end to prevent the cable 16 from retracting through the eyelet 26. An equal and identical cable 16 and handle 24 arrangement can be secured on the opposite side of the arm 14 and vehicle 11. Each length of cable optionally includes a spring or elastic portion 17, providing some give to act as a shock absorber upon impact with an obstacle.

The trimmer 10 can be fabricated as original equipment on the deck of a vehicle 11 during manufacturing. Alternatively, it can be a retrofit attachment to an existing mower. The trimmer head can be mounted in the front left or right corner or trimmer heads can be mounted at both corners, or mounted in the front center of the vehicle 11, and swing left or right or locked straight ahead and made to move up or down to cross uneven ground. As an alternative embodiment, two segments of cable attach to the arm in similar fashion to the steering mechanism of the embodiment of FIG. 1-2.

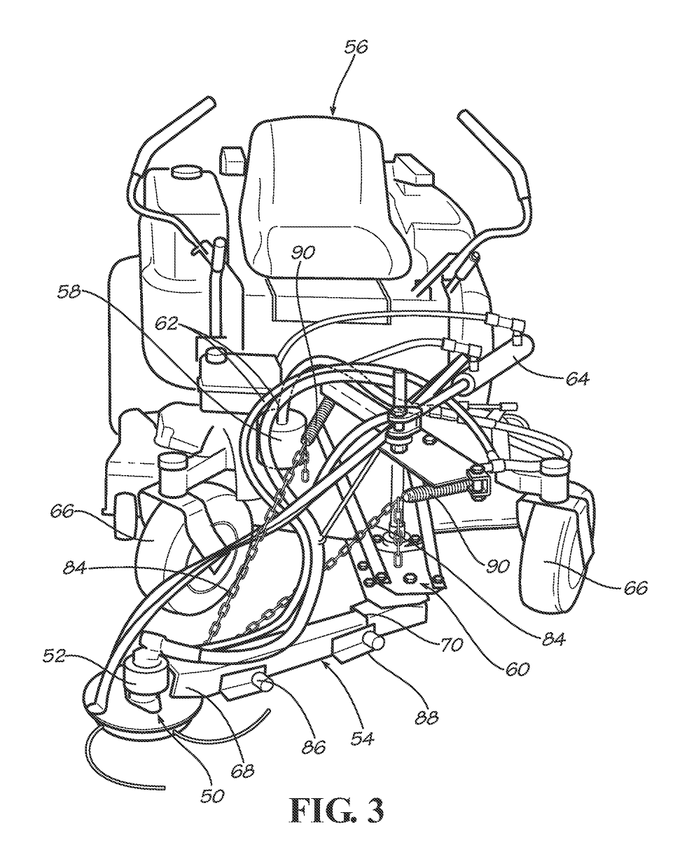

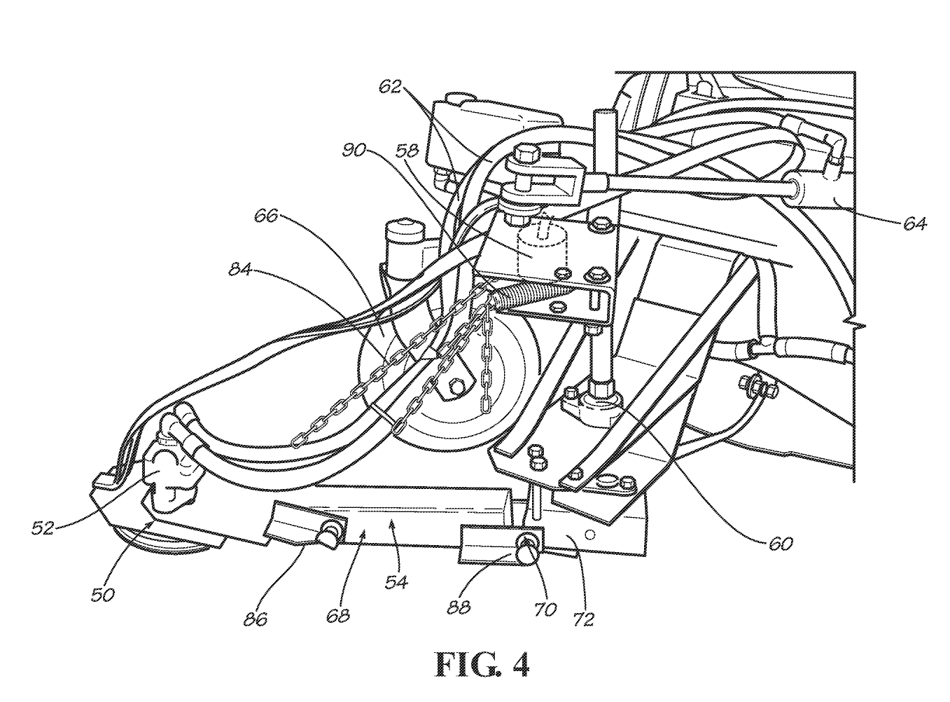

An alternate embodiment is shown in FIGS. 3-5. As shown in FIGS. 3-5 a weed trimmer tool head 50 is secured to an arm 54. The arm has a first end 68 and a second end 70. The first end 68 is secured to the weed trimmer 50 by a hinge or pivot joint or coupling 68. The weed trimmer 50 is powered by a hydraulic motor 52. The hydraulic motor 52 is connected to a hydraulic pump 58 by hose 62. The hydraulic pump 58 can be belt driven directly from the engine or from the blade drive of a lawnmower 56 using a belt and pulley arrangement. As shown, the arm 54 is secured to the vehicle 56 with a mounting or securing structure 60 such as a ball joint or swivel. The second end 70 of the arm 54 is secured to the securing structure 60 through a rotation mechanism 88. The rotation mechanism 88 can be a hinge, a pin, or an alternative device that provides a rotation motion with respect to the ground. A ball joint provides the arm 54 with the ability to move to the left and right and up and down with respect to the vehicle 56. A ball joint can be provided with a structure such as a trailer hitch.

The embodiment shown in FIGS. 3-5 preferably comprises a hydraulic cylinder 64 used to steer the arm 54 and attached tool head. As shown, the hydraulic cylinder 64 is secured with respect to one end on the arm 54 through the securing structure 60 and at the opposite end to a mounting location on the vehicle 56. In operation, a user manipulates the hydraulic cylinder 64 through hand or foot control pedals (shown in FIGS. 7 and 8) on the vehicle 56. For example, pressing a right pedal or moving a right handle, moves the arm 54 to the right, and pressing a left pedal or moving a right handle moves the arm 54 to the left. As shown, a pair of support chains 84 are secured to the arm 54 at a first end and secured to the securing structure 60 at a second end. The support chains 84 preferably incorporate springs 90 to provide a safe upward retraction of the trimmer 50 when the trimmer contacts a solid object.

Support wheels 66 of the drive vehicle traverse the ground and allow the attached trimming mechanism to move upward and downward with respect to changing terrain to maintain a constant cutting height.

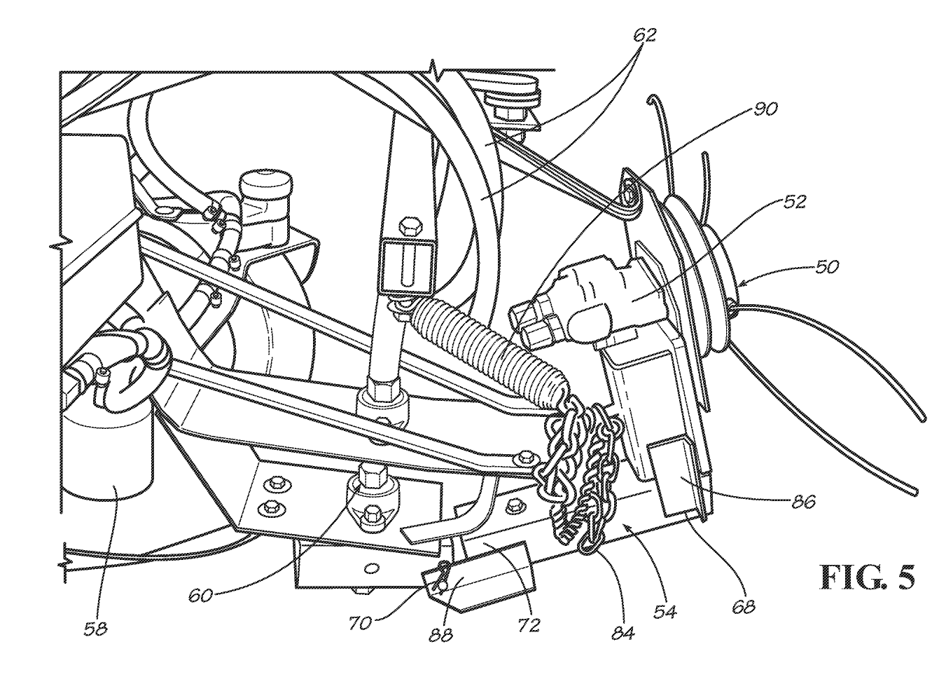

As shown in FIG. 5, a tilt-control pivot mechanism 88 allows the arm 54 to be pivot with respect to the ground and the vehicle. A second pivot mechanism 86 allows the trimmer 50 to be pivot vertically with respect to the arm 54.

FIG. 7 shows the trimmer head and associated equipment, viewed from the vantage point of an operator seated on the mower, and showing the use of a foot-operated hydraulic valve 78 to control the trimmer, including on/off actuation, and speed control. At least one foot pedal 78 activates the hydraulic cylinder 64 to steer the trimmer between objects such as bushes 80. Preferably, a right and left valve pedal 78 are secured to the vehicle to provide right and left direction movement of the trimmer.

FIGS. 7-8 show an alternate embodiment of a tool or trimmer head 50 including a saw mechanism, such as a chain saw blade. The saw blade is operated by the hydraulic motor 52 and can be installed and activated instead of, or in conjunction with, the string trimmer. FIG. 7 shows this embodiment in a vertical cutting, non-use storage or maintenance state rotated upwards toward the vehicle. FIG. 8 shows this embodiment in use in a horizontal state, rotated downward with respect to the ground surface.

While the invention has been described with reference to preferred and example embodiments, it will be understood by those skilled in the art that a variety of modifications, additions and deletions are within the scope of the invention, as defined by the following claims.

What is claimed is:

1. A trimmer comprising:
a cutter head;
an arm comprising a first end and a second end, wherein the cutter head is mounted to the first end of the arm and the second end of the arm is movably secured to a motorized vehicle; and
a steering mechanism for controlling the direction of deployment of the arm relative to the vehicle.

2. The trimmer of claim 1, wherein the steering mechanism comprises at least one length of flexible cable extending from the arm second end to the vehicle.

3. The trimmer of claim 2, further comprising at least one handle secured to the at least one length of flexible cable.

4. The trimmer of claim 2, wherein the at least one length of flexible cable comprises a spring.

5. The trimmer of claim 2, wherein the at least one length of flexible cable comprises two flexible cables having equal length, wherein the two flexible cables extend from the cutter head to the drive vehicle.

6. The trimmer of claim 1, wherein the steering mechanism comprises at least one pedal in cooperation with a hydraulic cylinder.

7. The trimmer of claim 1, further comprising a hinge providing vertical arm motion with respect to the vehicle.

8. The trimmer of claim 1, wherein the cutter head is powered by a fluid-powered motor.

9. The trimmer of claim 1, wherein the cutter head is powered by a belt and pulley arrangement in mechanical connection to the motor of the vehicle.

10. The trimmer of claim 1, wherein the arm is pivotally mounted to the vehicle to provide the arm second end with upward motion upon contact with an obstacle.

11. The trimmer of claim 1, wherein the cutter head comprises a device selected from a string trimmer, a brush blade, a chain saw blade and a combination thereof.

12. A lawn maintenance apparatus comprising:
a drive vehicle comprising motive means for transporting the lawn maintenance apparatus;
a trimmer head secured to the drive vehicle through a mounting structure; and
a fluid-driven steering mechanism for steering the trimmer head in relation to the drive vehicle, wherein the steering mechanism is manipulated by at least one pedal on the drive vehicle.

13. The lawn maintenance apparatus of claim 12, wherein the trimmer head comprises a device selected from a string trimmer, a brush blade, a chain saw blade and a combination thereof.

14. The lawn maintenance apparatus of claim 12, further comprising a trimmer angle adjustment mechanism for varying the angle of inclination of the trimmer relative to the ground.

15. The lawn maintenance apparatus of claim 12, wherein the trimmer head is powered by a device selected from a belt drive transmission coupled to the drive vehicle motive means, a gas motor, an electric motor and a combination thereof.

16. The lawn maintenance apparatus of claim 12, wherein the trimmer head is powered by a belt and pulley arrangement in mechanical connection to the motor of the vehicle.

17. The lawn maintenance apparatus of claim 12, wherein the trimmer head is powered by a fluid-powered motor.

18. The lawn maintenance apparatus of claim 12, wherein the mounting structure comprises an arm comprising a first end and a second end, wherein the trimmer head is mounted to the first end of the arm and the second end of the arm is movably secured to the drive vehicle.

19. The lawn maintenance apparatus of claim 18, wherein the arm is pivotally mounted to the drive vehicle in order to allow the arm second end to bounce upwardly upon contact with an obstacle.

20. A lawnmower attachment comprising:
a trimmer mechanism secured to the lawnmower through an arm comprising a first end adjustably secured to the lawnmower and a second end secured to the trimmer mechanism;
an angle manipulation mechanism for determining the angle of the arm with respect to the lawnmower, wherein the angle manipulation mechanism is manually operable; and
an angle adjustment mechanism for varying the angle of inclination of the trimmer mechanism relative to the ground.
